(19) United States
(12) Patent Application Publication
(10) Pub. No.: US 2006/0013929 A1
(43) Pub. Date: Jan. 19, 2006

(54) Visually-appealing microwaveable frozen meal

(76) Inventors: Susie Morris, Akron, OH (US); Carl Hamilton, Lausanne (CH); Kathy Klingensmith, Hiram, OH (US); Devon Givens, North Royalton, OH (US); Karen Stockman, North Royalton, OH (US); Nicole Mydy, Hudson, OH (US); Jim Smith, Hudson, OH (US); Debbie Bester, Sagamore Hills, OH (US); Richard Ludwick, Stow, OH (US)

Correspondence Address: BELL, BOYD & LLOYD LLC, P. O. BOX 1135, CHICAGO, IL, 60690-1135, US

(21) Appl. No.: 10/892,365

(22) Filed: Jul. 16, 2004

(51) Int. Cl. A22C 17/10

(52) U.S. Cl. 426/383

(57) ABSTRACT

A visually-appealing, multi-component, packaged microwaveable frozen meal that includes at least two different, discrete, individually frozen edible components assembled on a support member to form the frozen meal that mimics a prepared meal, and a microwaveable film disposed adjacent the frozen components that conforms and adheres sufficiently tightly to the components and the support member is disclosed. The film and the support member form an enclosure having a reduced pressure therein. The film is at least sufficiently translucent or transparent so that a consumer can readily view a portion of the frozen meal as a complete, multi-component meal ready for serving.

### FIELD OF THE INVENTION

This invention relates to a visually-appealing, multi-component packaged microwaveable frozen meal. It further relates to a process for preparing the frozen meal, a multi-component frozen meal package, and a storage-stable meal.

### BACKGROUND OF THE INVENTION

The history of freezing food products is detailed and it is well known in general to freeze foods and prepare foods for freezing. Frozen foods, frozen meals, and methods of preparing the same are known in the art in general. Many different kinds of frozen food products are available in the market or described in the prior art, and a few of these are described below in more detail.

U.S. Pat. No. 4,708,881 discloses an improved method of producing frozen food including at least two steps of freezing. Food is frozen at a temperature in the neighborhood of a temperature at which the maximum crystallization of ice takes place. Then, the food is processed, and frozen again at a temperature which is not higher than −10° C.

U.S. Pat. No. 5,873,218 discloses a method of packaging a product by heat shrinking a low gauge, low shrink force, polyester shrink film to a rigid container. The lidding film engages around the outside of the container, thereby protecting the contents and providing evidence of tampering. The packaged product can be heated and will generally vent steam, while maintaining tamper resistance.

U.S. Pat. No. 6,183,789 discloses a steamable pouch meal for preparation in a microwave oven. The pouch meal includes a plurality of frozen food pieces including at least two different types of food and, optionally, a quantity of frozen sauce or liquid seasoning, and a pouch containing the frozen food pieces. The pouch is at least partially made of a mesh material, with the mesh material adapted to permit a first portion of steam produced upon heating the pouch and its contents to escape from the pouch while maintaining a second portion of steam within the pouch to create a steam environment therein for heating the food pieces. The mesh material additionally serves to retain sauce or liquid seasoning and juice from the food pieces within the pouch.

U.S. Pat. Nos. 6,251,447, 6,605,307, and U.S. Publication No. 2001/0016219 each disclose plated frozen meals including a plate, a first group of individually frozen predominantly meat-based ingredients positioned on the plate, a second group of individually frozen predominantly carbohydrate-based or predominantly vegetable-based ingredients positioned on the plate, and at least one pellet of frozen sauce. The at least one pellet of frozen sauce is positioned such that when it thaws it facilitates the thawing or heating of at least one of the first or second groups of ingredients. The patent is also directed to a method of increasing the rate of thawing or heating of a frozen plated meal.

U.S. Pat. No. 6,312,744 discloses a process for microwave heating a pre-packaged frozen entree so that the heated pre-packaged frozen entree exhibits improved taste or appearance characteristics. The process includes providing the pre-packaged frozen entree in a container. The frozen entree has at least two food components. Each of the food components is discretely and loosely frozen. One of the food components is removed from the container. The food components that remain in the container are heated with microwave radiation for a first selected time interval. The food components are replaced into the container and another one of the food components is removed from the container. The food components that remain in the container are heated with microwave radiation for a second selected time interval.

U.S. Pat. No. 6,488,973 and U.S. Publication No. 2003/0017235 each disclose a frozen food product that includes a raw protein portion, a raw or an only partially cooked or blanched vegetable portion and a sauce, contained in a sealed cooking pouch made primarily of paper and a susceptor layer, preferably aluminum, which may be placed in an oven or microwave oven so as to cook the contents of the cooking pouch. The raw protein product is preferably one of fish, beef, poultry, pork or veal. The vegetables are raw or blanched vegetables such as julienne peppers, celery, carrots, onions, zucchini or broccoli. The blanched vegetables are only partially cooked so that the time remaining to complete cooking of the vegetables is approximately the same as the time required to cook the raw protein portion.

U.S. Pat. No. 6,630,237 discloses a peelably sealed package that includes a web having a peelable layer and a substrate having a surface layer. The peelable layer of the web and the surface layer of the substrate are peelably sealed to each other in one or more selected areas.

U.S. Pat. No. 6,667,067 discloses a package that allows for butchering and packaging of fresh red meat at a centralized facility. The package includes an impermeable tray supporting the product, a first film sealed to the tray for enclosing the product, means defined within the first film for exchanging gases into and out of the package, and a second impermeable film enclosing the first film, such that removal of the impermeable film provides for the exchange of gases into and out of the package.

International Publication No. WO 98/12937 discloses a process for the preparation of a frozen meal by putting the components of the meal into molds to form bricks, subjecting the thus filled molds to a freezing step such as by brine solution, demolding the frozen meal, and packaging the deep frozen meal.

International Publication No. WO 03/020608 discloses a self-venting microwaveable package of food product that includes: a) a rigid or semi-rigid, flat or shaped, base; b) a food product loaded onto the base a), and c) a flexible thermoplastic film enclosing the food product on the support member. The flexible film is draped over the food product, by vacuum and/or air pressure, in a vacuum skin packaging arrangement, substantially conforming to the shape of the food product and being sealed to the base outside the periphery of the food product.

International Publication No. WO 03/061959 discloses a microwaveable package that includes a base, a bottom web, a food product, and a top web. Methods of making the microwaveable packages are also disclosed.

International Publication No. WO 03/090568 discloses a deep-frozen processed food product consisting of at least two different, separate constituents, and characterized in that the constituents together form a compact individual unit in the shape of a disk in the deep-frozen state. The publication also relates to a method for producing the deep-frozen, disk-shaped unit of processed food, and to the use of the disk-shaped unit, especially for patients cared for in a hospital.

International Publication No. WO 03/103414 discloses a method of producing a frozen risotto or a like ready-to-eat dish based on rice, barley, wheat or spelt. For risotto the steps include adding to rice the necessary liquid and particulate ingredients and cooking all the above ingredients up to desired cooking degree, rapidly cooling the thus prepared risotto, and feeding it into a dosing apparatus, which forms sphere-like portions of a predetermined weight or volume that are subjected to ultra-fast freezing and then packaged.

In today's hurried world, little time is left for the complicated processes of cooking a gourmet meal. Accordingly, resort has been made to taking advantage of processed or frozen, prepared meals. These meals come in various forms of pre-cooked food and provide a wide range of entrees and flavors, some of which are more suitable for consumption and more pleasing than others. The offerings of the processed food industry, however, have not yet achieved the quality of a restaurant-prepared or home-cooked meal. The reheating of frozen, precooked food cannot generally provide a flavor and texture that approaches that of fresh food.

In addition, conventional packaged frozen meals tend not to be particularly visually-appealing to the consumer. For example, they are typically packed in an opaque box, a pigmented plastic bag or sack, or the like. These conventional frozen meals are bought primarily for their convenience and/or cost, not for their aesthetic appeal or quality. Frozen food products are often purchased by individuals or families who do not have the time to prepare home-cooked meals and who do not want to spend the extra money to purchase ready-to-eat meals or foodstuffs from a restaurant. Thus, there exists a need for frozen meals that are visually-appealing to the consumer while in their packaging, and that provide fresh, quality food such as that similar to ready-to-eat restaurant quality.

### SUMMARY OF THE INVENTION

The present invention relates to a visually-appealing, multi-component, packaged microwaveable frozen meal that includes at least two different, discrete, individually frozen edible components assembled on a support member to form the frozen meal that mimics a prepared meal. The components are palate complementary to together form, after heating, a complete multi-component meal ready for serving. The meal also includes a microwaveable film disposed adjacent the frozen components that conforms and adheres sufficiently tightly to the components and the support member. The film, with the support member, forms an enclosure provided with a reduced pressure therein. The film contacts the support member in a portion of the areas not covered by the food components. The film is also at least sufficiently translucent or transparent so that a consumer can readily view a portion of the frozen meal as a complete, multi-component meal ready for serving. Preferably, the entire frozen meal is microwaveable at the same time so that removal of the film and/or support member is required only after cooking.

In a preferred embodiment, the components are pre-cooked and pre-frozen prior to being assembled and arranged on the support member. The components advantageously include a protein source, a vegetable source, or a starch source, or a combination of two or all three components. The protein source includes meat, poultry, seafood, or a combination thereof; the vegetable source includes carrots, broccoli, spinach, peas, peppers, beans, corn, or a combination thereof, and the starch source includes rice, pasta, potatoes, or a combination thereof. In one embodiment, the food components are at least partially separated on the support member.

The microwaveable film preferably includes a thermoplastic component. Application of the film to the meal favorably reduces or avoids the formation of air pockets between the film, the food components, and the support member, thereby minimizing or preventing visible ice crystal formation within the packaged frozen meal, freezer burn of the frozen meal, or both on the food components during storage at freezer temperatures.

The meal preferably includes an outer enclosure for the meal that surrounds the meal and contains an aperture therein to permit the consumer to view a significant portion of the meal through the outer enclosure. In a preferred embodiment, the aperture is sufficiently large so that at least about 30 percent of the meal can be seen through the outer packaging. In another embodiment, the outer enclosure includes a polygonal box having a base and made of a sufficiently rigid material so that it remains upright when disposed on the base. Preferably, the aperture is disposed in or across one or more sides rather than the base.

The present invention also relates to a process for preparing a visually-appealing, multi-component, packaged, microwaveable, frozen meal. The process includes freezing a plurality of different, discrete edible components sufficiently so that each type of discrete component retains its shape and distinctness from different types of components, arranging the different edible components on a support member to provide a complete frozen meal that mimics a prepared meal, and sealing the complete frozen meal with a film disposed upon the frozen components in a manner that conforms and adheres the film sufficiently tightly to the components and the support member so as to form an enclosure having a reduced air pressure therein. The film contacts the support member in a portion of the areas not covered by the components and is sufficiently translucent or transparent so that a consumer can readily view a portion of the frozen meal as a complete, multi-component meal ready for serving. In one embodiment, the process further includes packaging the meal in an outer enclosure that surrounds the meal and contains an aperture therein to permit the consumer to view a significant portion of the meal through the outer enclosure. In another embodiment, the process further includes reducing the air pressure of the enclosure by at least about 90 volume percent of the air initially present during the sealing of the film, and arranging the food components to be separated on the support member.

The present invention further relates to a multi-component, frozen meal package that includes a support member on which is disposed a multi-component frozen meal; and an outer enclosure with at least one aperture that displays at least about 50 percent of the complete frozen meal. The frozen meal and support member are sealed with a film disposed upon the meal in a manner that conforms and adheres the film sufficiently tightly to the food components of the meal and support member. The film and the support member form an enclosure that is provided with a reduced pressure therein. The film further contacts the support member in a portion of the areas not covered by the food components. The film is also sufficiently translucent or transparent so that a consumer can readily view a portion of the frozen meal as a complete, multi-component meal ready for serving. Each of the above embodiments also relates to the method and frozen meal package. Moreover, the package preferably includes a set of instructions for preparing the frozen meal.

The present invention also relates to a storage-stable meal that includes at least two different, discrete, individually pre-frozen edible components arranged on a support member to form the storage-stable meal and a microwaveable film disposed adjacent the pre-frozen components that conforms and adheres sufficiently tightly to the components and the support member. The film and support member form an enclosure having a reduced pressure therein, with the film contacting the support member in a portion of the areas not covered by the food components. The film is sufficiently translucent or transparent so that a consumer can readily view a portion of the frozen meal as a complete, multi-component meal ready for serving. The entire storage-stable frozen meal is simultaneously microwaveable and can be stored essentially free of visible freezer burn or visible ice crystal formation for at least about one month at freezer temperatures.

In one embodiment, the taste and freshness of the meal are not detectably different to the consumer after at least about one month under frozen conditions. In another embodiment, the storage-stable meal is at least essentially free of freezer burn and visible ice crystal formation after at least about three months under frozen conditions. In a preferred embodiment, the storage-stable meal is at least essentially free of freezer burn and visible ice crystal formation after at least about six months under frozen conditions. In each embodiment, preferably the storage-stable meal is entirely free of freezer burn and visible ice crystal formation under frozen conditions. More preferably, there is no detectable ice crystal formation when the complete meal is stored under frozen conditions.

### BRIEF DESCRIPTION OF THE DRAWINGS

Further features and advantages of the invention can be ascertained from the following detailed description that is provided in connection with the drawing(s) described below:

FIG. 1 illustrates an embodiment of a frozen meal according to the present invention; and

FIG. 2 illustrates another embodiment of a frozen meal according to the present invention.

### DETAILED DESCRIPTION OF THE PREFERRED EMBODIMENTS

The frozen meals of the present invention are complete frozen meals that are surprisingly and unexpectedly more visually-appealing to the consumer than conventional frozen food products or meals, and are more fresh-tasting, as well. The components of the meal are fresh and attractive with vibrant colors and varied textures. The frozen meals are ready-to-eat after being cooked or thawed. The enhanced appearance and quality of the packaged frozen meal is designed to advantageously attract non-users of frozen food as well as consumers already used to frozen foods. Unlike conventional frozen foods, the inventive meals of this application provide the convenience of a microwaveable meal with the taste and presentation of a prepared or restaurant meal.

The invention surprisingly and unexpectedly provides a visually-appealing, multi-component, packaged microwaveable frozen meal that includes at least two different, discrete, individually frozen edible components assembled on a support member that mimics a prepared meal, e.g., from a restaurant. The discrete, frozen components form the frozen meal, and are palate complementary, to together form, after heating, a complete multi-component meal ready for serving. A microwaveable film disposed upon the frozen components conforms and adheres sufficiently tightly to the components and the support member to form an enclosure with the support member that is provided with a reduced pressure therein.

The film also contacts the support member in a portion of the areas not covered by the food components. Typically, there may be some portion of the support member not covered by the food components, such as the spaces between discrete components. As used herein, the language “areas not covered by the food components” refers to spaces on the support member where is not a food component between the film and the support member. The portion of the support member contacted by the film may be, for example, the rim of the support member, the bottom surface of the support member, any space of at least about a half centimeter or more between food components on the support member, or any combination thereof.

Additionally, the film is at least sufficiently translucent or transparent so that a consumer can readily view a portion of the meal as a complete, multi-component meal ready for serving. Advantageously, the invention provides for an appealing-looking product when viewed either in or out of the outer enclosure that forms a package for displaying the product for sale, and especially when the product is heated and presented as a complete meal.

Often, with frozen meals that include different components and different sizes, a consumer must keep an eye on the meal as it is heated because different ingredients heat at different rates. The present invention can provide a frozen meal that can be cooked with minimal consumer involvement during its thawing and heating. Typically, the meals are heated in the microwave, and are ready for serving in less than ten minutes, preferably in less than eight minutes. The resulting meal is evenly cooked. This can be achieved in part by preferably selecting components that are sized and shaped to provide for substantially uniform cooking for different types of components.

The edible components can include any type of food that is sufficiently solid to at least substantially retain its shape and remain discrete under the pressure of a sealing film, or any combination of such foods. As used herein, “discrete components” refers to a plurality of edible types of components that are separately identifiable even when dispersed adjacent to each other. For example, jambalaya, risotto, or chili are not discrete components as defined herein. The discrete types of components enhance the non-processed appearance of the frozen meal. The components can be frozen to facilitate this shape retention.

The term “palate complementary” is used herein to mean food components that complement each other in conventional meals. Various examples are provided herein but the edible components preferably include a protein source, a vegetable source, or a starch source, or a combination thereof. The protein source can include, for example, meat, poultry, seafood, dairy, or a combination thereof. The vegetable source can include, for example, carrot, broccoli, spinach, peas, peppers, beans, wheat corns, or a combination thereof. The starch source can include, for example, rice, pasta, potatoes, or a combination thereof. Each source is generally processed as minimally as possible to minimize or avoid loss of freshness and taste of the meal that typically occurs during conventional food processing. When an optional sauce is included, it is typically water-based and will include one or more of herbs, wine, lemon, peanut, garlic, fruit, hoisin, ginger, or the like, or any combination thereof.

The edible components, e.g., a protein source, vegetable source, and starch source, are preferably pre-cooked and pre-frozen or are edible upon thawing without need for cooking. Pre-cooking is not always necessary, however, for components that require little cooking, such as certain meats, or certain seafood such as fish or prawns. The vegetable source is preferably blanched to increase food safety. The meal may include, for example, whole potatoes. Some or all of the edible components can be whole or cut into pieces of varying sizes. For example, for a child-friendly frozen meal or one for an arthritic adult, smaller bite-sized pieces can be used that are ready to eat, while for typical adult- or teenager-appropriate meal a larger multi-bite slab of food can be used to increase the visual appeal or to promote suitable cooking properties. One example of a child-friendly meal according to the invention might include a protein source including hot dog or hamburger, a starch source including french fries or tater tots, and a vegetable source including corn or carrots, with the protein source being provided in bite-sized pieces and the remaining components being sized as when conventionally served.

Preferably, the meal is a mixture of more than one type of food component, such as meat, pasta, vegetables, rice, sauce, or any combination thereof. The meal may include food components each of which have a different consistency. The invention also allows for the preparation of frozen meals having different components of different consistencies, including chunks of food or toppings or multi-layers. For example, the invention includes foods where adjacent layers can be formed from different food components. The invention provides for multi-component meals that include large pieces of food, more liquid or saucy meals including smaller pieces of food, and the like. In a most preferred embodiment, at least three different types of components, such as a protein source, a vegetable source, and a starch source are included to form a complete meal. Preferably, the edible components are sufficiently solid to avoid substantial movement thereof on the support surface and to avoid substantial change in shape after the film is applied.

Generally, the meals incorporate a variety of food colors and textures. In one embodiment, the surface of the meal is irregular or rough due to the layering of different components. The meal preferably includes large vegetables and whole cuts of meat, and visible herbs and spices and garnishes, such as pats of butter, whole cashews, pine nuts, or shaped pieces of cheese. Examples of meals that can be prepared include: shrimp and scallops in a white wine sauce, parmesan crusted chicken breast, roasted pork loin with sauteed apples, pan seared chicken in a mushroom chardonnay reduction, and salmon in lemon caper sauce. Preferably, the food components are separated on the support member in the same way that a restaurant would prepare the different cooked components on a plate or the way that one would select and arrange different cooked or prepared components onto their plate from larger cooked portions or serving dishes.

A frozen meal according to the invention typically includes any suitable amount of food, for example, about 200 grams to 800 grams, preferably about 250 grams to 600 grams, and in one embodiment more preferably about 300 grams to 450 grams, of food components on the support member. Less food can be used for a low calorie or dietary-type meal, while more food can be included to provide an extra large or oversized meal. The different types of food components can be provided in any suitable ratio, with each of any protein, vegetable, and starch that is present being included in an amount of about 20 to 49 weight percent, preferably about 25 to 45 weight percent of the food components when three components are included. For example, each type of food can be present in about 60 grams to about 200 grams of the entire frozen meal. One example would be to include about 70 grams to 130 grams, preferably about 80 grams to 160 grams, for each of protein and starch, with about 60 to 120 grams of vegetable(s). If an optional sauce is included, the sauce is typically present in an amount of about 50 grams to 150 grams, preferably about 60 grams to 140 grams.

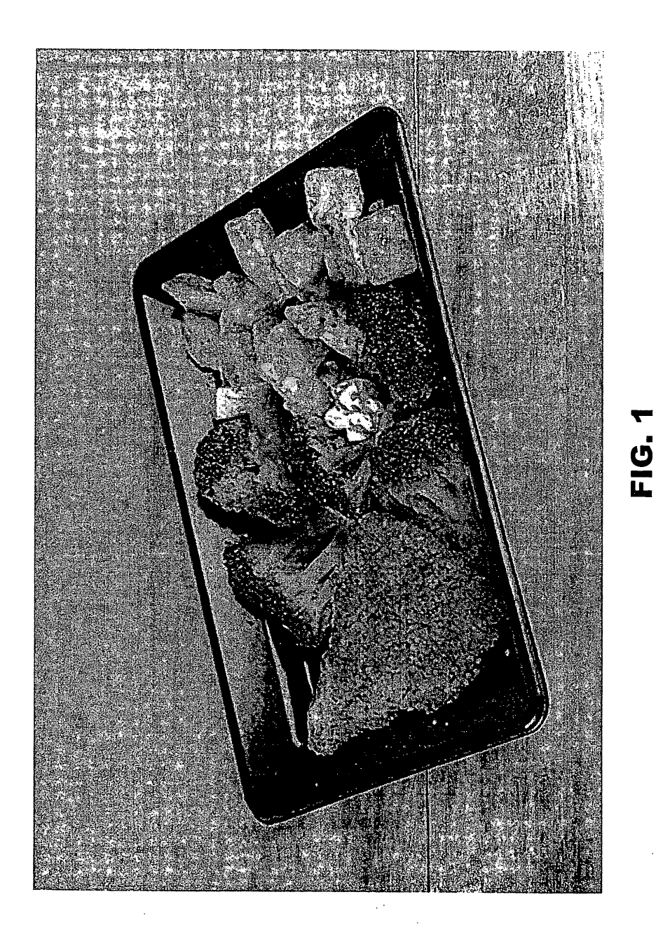

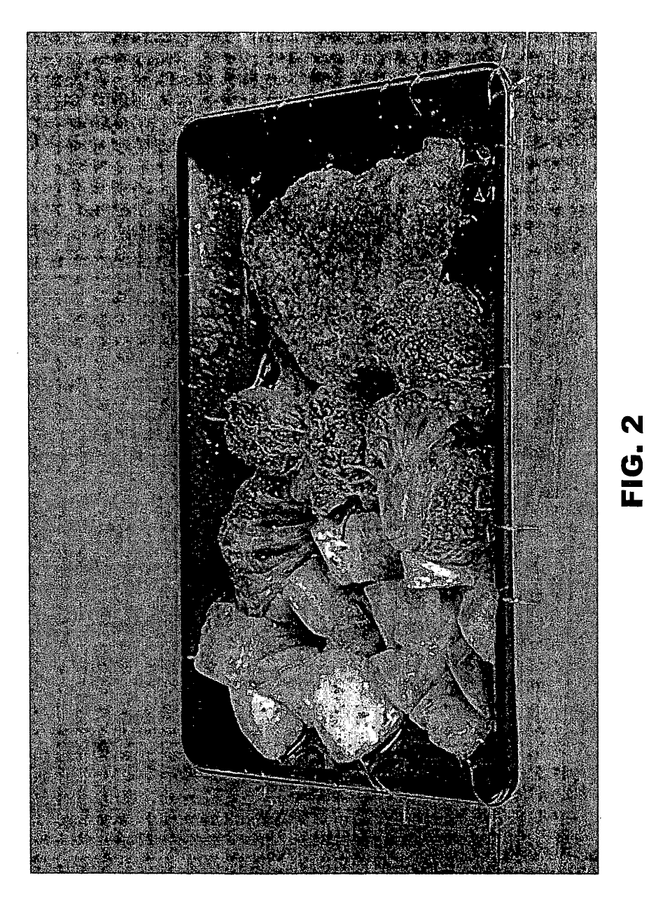

FIG. 1 illustrates a meal of parmesan crusted chicken breast with seasoned roasted sweet potatoes and broccoli spears, e.g., with lemon-herb butter, disposed on a support member according to the invention. FIG. 2 illustrates the same meal after providing a film over the meal and support member, and after removing a substantial amount of air to form a vacuum between the film and support member.

The meal advantageously provides restaurant-sized portions for one individual, which contributes to the feeling of eating food from a restaurant. Large portions of components, such as whole chicken breasts or hamburger or fish fillets, typically range from about 6 to 24 ounces, preferably about 11.5 to 15.5 ounces, in weight, although other suitable sizes can be used. While the meal of the invention may also be packaged to include single serve portions, it is also possible to provide couple-sized portions to be shared, or even family-sized or family-sized plus portions. The family-sized might provide portions for 3-4 people, while the family-sized plus portion might provide food for 5-6 persons. The invention differs from the prior art in that multiple discrete food components are provided in a single package for ease of reheating and serving.

The edible components are disposed upon a support member, which may be any rigid or semi-rigid article on which the edible components can be placed and supported, such as a plate, tray, cup or bowl. The support member may be configured and adapted to be any suitable shape and size to retain the edible components of the frozen meal in conjunction with the film, preferably a shape having a base portion on which the components are disposed that is substantially or entirely flat, concave, open conical (i.e., with the cone at an angle greater than about 60 degrees from its axis), or any combination thereof. Preferred support member shapes include circles, ovals, rectangles, and squares.

The support member optionally, but preferably, includes a rim to facilitate retaining the edible components at least substantially in place, to facilitate placement, conformance, and adherence of the film to the edible components, or a combination thereof. The rim can be integrally formed or provided separately and be of any suitable shape, but preferably it corresponds to the shape of the support member and is shaped to be a flat or curved beveled edge that is raised above the level of the base portion of the support member, and the rim is preferably disposed adjacent and along a portion of the edge of the support member. Preferably, the rim has a smaller height than the height of the largest edible components and it is preferably raised on the side of the support member on which the edible components are disposed. The rim is preferably configured and adapted to enhance the visual appeal of the frozen meal, and in a preferred embodiment is not required for sealing the film to the edible components or support member. In a preferred embodiment, the rim is configured and dimensioned with the support member to act like a conventional plate, such as those available in restaurants. Preferably, the support member and rim are not configured in the form of a conventional freezer tray. Preferably, the support member does not contain physical dividers or separated portions that separate types of food components, as with certain types of plates that are designed to keep flowable foods separated. Indeed, some contact at or between the edges of different types of food components is suitable.

In one embodiment, the support member is at least substantially translucent, preferably substantially transparent, and more preferably transparent, to further increase the visual appeal and entice the consumer into buying the inventive frozen meal. In another embodiment, the support member is transparent to microwaves, to facilitate the quick and even cooking of the meal in the microwave. Any suitable susceptor technology can be used in, on, or adjacent the support member to facilitate microwaving of the edible components. The support member may be made of one or more microwave-safe materials, preferably including one or more plastic materials that withstands freezing and heating in a microwave, and preferably also in a conventional oven. Suitable materials include, for example, plastics or plastic/paper laminates such as crystalline polyester, paper coated with crystalline polyester, a composite polyethylene terephthalate (PETs), and polypropylene, or any combination thereof.

In a preferred embodiment, the support member is a substrate with a wide rim, i.e., a rim that provides a raised edge that extends under the edible components, preferably a rim that covers a zone of about 5 to 50 percent of the surface area of the support member. Although the support member may include compartments, preferably the support member is non-compartmentalized to contribute to the feeling of eating a restaurant-style meal.

The frozen meal of the invention also includes a microwaveable film disposed adjacent the frozen components that conforms and adheres sufficiently tightly to the components. Typically, the microwaveable film includes any safely microwaveable thermoplastic component, including polyamides; polyolefins including polyethylenes, polypropylenes, or any combination thereof; polyvinyl chlorides, ionomeric materials; or polyurethanes, or any combination thereof. One exemplary film includes a composite polyethylene terephthalate (PET). Preferred films are commercially available from Cryovac® of Duncan, S.C., in connection with its Darfresh® Vacuum Skin Packaging Systems. Examples of suitable films are those described in U.S. Pat. Nos. 6,599,639, 6,602,455, 6,610,392, 6,630,237, 6,632,408, 6,656,548, 6,667,067, 6,667,082, 6,670,023, 6,673,406, 6,677,014, and 6,682,825, which are incorporated herein by reference. The film may be a monolayer film or a co-extruded, multi-layer film. Preferably, the film is an oxygen-scavenging film.

The microwaveable film generally has a thickness sufficient to minimize or prevent loss of flavor, color, taste, or a combination thereof, over a period of time when stored in a freezer. This period of time can be from about 1 day to 6 months, and is preferably longer than about 30 days. The thickness of the film is generally from about 150 μm or less, preferably about 100 μm or less, and more preferably about 75 μm or less, to facilitate viewing the frozen meal therethrough. In a preferred embodiment, the film has a thickness of about 10 μm to 125 μm, preferably about 20 μm to 60 μm. The film is generally not suitable for cooking in a conventional oven, as it would likely melt onto the edible components during heating. Preferably, the film is not permanently sealed to the support member, and more preferably it is not sealed to the support member, but is merely disposed adjacent to the support member and readily released when the consumer is ready to eat the food contained therein. It is possible that the film is sealed to the edges or bottom of a support member, but it preferably releases readily from the edible frozen meal components when desired.

As used herein, “conforms and adheres sufficiently tightly” refers to the film adapting sufficiently to the contours of the components to provide clear identification and viewing of the components.

The film generally keeps the components at least substantially stationary, preferably stationary, on the support member, which facilitates retaining discrete edible components to enhance the visual appeal of the inventive frozen meal. Typically, the components are secured such that there is little or no size or shape distortion, and little or no migration of sauce, juice, or other liquids between the components before the film is released from the edible components and/or support member after any microwaving. The film facilitates minimizing or preventing the mixing of components together during heating, while preferably keeping the individual components at least partially or entirely separated, and discrete, on the support member. Thus, the film molds to and adheres to the frozen meal components, thereby providing a visually-appealing appearance and presentation.

The film forms an enclosure with the support member that is provided with reduced air pressure within the enclosure. Typically, the pressure within the enclosure is below ambient air pressure. Preferably, the reduced-pressure is below about 750 torr. More preferably, the pressure is below about 380 torr within the enclosure. In the most preferred embodiments, the air pressure is reduced to below about 150 torr, or preferably is as close to a vacuum as commercial food-grade pumps typically can provide, i.e., no substantial air pressure exists within the enclosure. An exemplary vacuum pressure is about 35 torr to 120 torr. In one embodiment, the volume of air remaining in the enclosure is less than about 10 percent of the volume of the components. Preferably, the volume of air remaining is less than about 5 percent of the volume of the components, and more preferably, the volume of air remaining is less than about 1 percent of the volume of the components.

Advantageously, the film is applied to the meal to reduce or avoid the formation of air pockets between the film and the edible components and/or support member, thereby minimizing or preventing visible ice crystal formation, freezer burn, or both. Both ice crystals and freezer burn contribute to the unappetizing appearance and loss of taste of conventional frozen foods and frozen meals. Ice crystals usually destroy the structure of food, particularly at its surface where the taste and smell are typically provided when food is consumed, and the ice crystals can also hide the color of food. Freezer burn typically dries out the surface of food as water is pulled from the food itself into crystal formation. It generally appears as grayish-brown leathery spots on frozen food. Freezer burn often occurs when air reaches a food's surface and dries out the food, which typically occurs when food is not securely wrapped in air-tight packaging. Color changes can also result from chemical changes in the food's pigment. Preferably, the type, thickness, and structure (e.g., uni-layer or multi-layer) of the film are sufficient to minimize or avoid air pockets when the edible components are frozen and then sealed adjacent the support member with the film.

The film is preferably elastic, readily releases or peels off when desired by the consumer, and is self-venting particularly during microwaving. The film aids in steaming food to perfection during heating in, for example, the microwave. This results in consistent reconstitution across components, resulting in the proper textures and temperatures of the food. It also helps in cooking raw fish and seafood during reconstitution while minimizing or avoiding localized hot spots that can undesirably overcook a portion or the edible component(s). In a preferred embodiment, once heated, the film readily releases from the meal either by itself during heating or manually, leaving the attractive, discrete components of food intact and undisturbed.

The film is at least sufficiently translucent or transparent so that a consumer can readily view a portion of the frozen meal as a complete, multi-component meal ready for serving. Preferably, the film is at least substantially transparent, and more preferably, the film is transparent. In a most preferred embodiment, the film acts as a “second skin” and the consumer does not readily see the film. The film in this most preferred embodiment is essentially invisible to the eye at various angles, e.g., over about a 60 degree viewing angle when looking transversely at the film surface. Preferably, the film has a minimized gloss or shininess to minimize the ability of a consumer to see it, which increases the visual appeal of the frozen meal within to approximate the look of a restaurant meal.

The frozen meal can be provided with a package. In this embodiment, the frozen meal and support member are provided with an outer enclosure that surrounds the meal and contains an aperture therein to permit the consumer to view the meal, or a portion thereof, through the outer enclosure. As used herein, when used in connection with the outer enclosure, “surrounds” refers to one or more materials or layers that are disposed about the frozen meal, including the film and support member, in a manner that retains the frozen meal and preferably that facilitates carrying the frozen meal, displaying the frozen meal, or both. Preferably, the outer enclosure includes a handle to facilitate carrying the frozen meal, a base to facilitate display to consumers, an aperture comprising one or more openings permitting a consumer to readily view the frozen meal therein, or any combination thereof. Preferably, the outer enclosure completely surrounds the meal except for the aperture, i.e., the aperture provides one or more openings that permit the frozen meal to be displayed with only the film disposed between the frozen meal and the consumer. In another preferred embodiment, the outer enclosure, including the aperture, completely surrounds the meal, i.e., the aperture provides one or more openings that are closed off by one or more aperture materials, such as a second layer of film that is different or the same as that used to surround the frozen meal. The aperture material(s) are typically at least substantially translucent, preferably at least substantially transparent, and more preferably sufficiently transparent so that the consumer can readily view a portion of the meal through the enclosure and the film.

Advantageously, the aperture comprises one or more openings that collectively are sufficiently large to permit a consumer to view a significant portion of the meal through the outer enclosure. As used herein, “a significant portion of the meal” refers to at least about 30 to 100 percent of the meal. Preferably, the aperture is sufficiently large so that at least about 35 percent, and more preferably at least about 50 percent, of the frozen meal components can be seen through the outer enclosure. More preferably, the aperture is sufficiently large so that the consumer can see at least about 60 to 99 percent of the meal, and in one most preferred embodiment at least about 75 to 95 percent of the meal. The aperture allows consumers to view almost the entire contents of the meal. In all embodiments, the percentage of displayed amount refers to one side of the support member. In the embodiment where the support member is at least substantially translucent so the edible components can be viewed from either side, it is desired that the outer enclosure (i.e., packaging) also includes a portion of the aperture on each side of the support member. This can advantageously provide a support member disposed in an outer enclosure that permits consumers to view a portion of the frozen meal from at least two sides, particularly when the support member can be disposed in an angled or upright fashion that stands on its own in conjunction with the outer enclosure.

In one embodiment, the outer enclosure is a flexible sleeve or a polygonal box. The flexible sleeve typically conforms at least in part to the shape of the support member. When a polygonal box is used, preferably it has a base and is made of a sufficiently rigid material so that it can remain upright when disposed on the base. Such materials include, for example, cardboard, paperboard, or coated paperboard.

The box is at least substantially, and is preferably, triangular, circular, square, rectangular, or trapezoidal, or any combination thereof, with a flat portion or segment for a base. A more preferred shape is rectangular. “At least substantially,” when referring to a box shape, means that the box shape may have one or more rounded edges or corners. Optionally, but preferably, the outer enclosure includes one or more handles that facilitate carrying of the frozen meal. Preferably, the boxes are sized and dimensioned to be stackable to permit interesting displays in a retail environment, e.g., at a grocery store, convenience store, or the like.

The outer enclosure may also be designed to resemble a carry-out container, such as a box or bag, from a restaurant. In this embodiment, the outer enclosure can be provided with restaurant logos, brand names, attractive designs, vibrant colors, and the like. FIG. 3 illustrates a preferred embodiment of the outer enclosure with an aperture to facilitate viewing of a portion of the frozen meal, and that includes handles to facilitate placement and/or transportation of the meal, e.g., from the market to a consumer's home.

The invention further relates to a process for preparing a visually-appealing, multi-component, packaged, microwaveable, frozen meal. The process includes freezing a plurality of different, discrete edible components so each retains its shape and distinctness, arranging the different edible components on a support member to provide a complete frozen meal that mimics a prepared meal, and sealing the complete frozen meal with a film disposed upon the frozen components that conforms and adheres sufficiently tightly to the components and the support member so as to form an enclosure having a reduced pressure therein. The film contacts the support member in a portion of the areas not covered by the food components. In addition, the film is sufficiently translucent or transparent so that a consumer can readily view one or more of the discrete edible components therethrough and, overall, view a portion of the frozen meal as a complete, multi-component meal ready for serving.

The discrete types of components of the meal are preferably individually quick frozen prior to assembly on the support member. The edible components are not frozen together to form pellets, bricks, or any other type of monolithic structure, which detracts from the visual appeal of the meal. In one embodiment, all but one of the component types are frozen. Preferably, all of the component types are frozen. In either situation, this pre-freezing facilitates retaining the individuality of the discrete types of components. Pre-freezing permits tailored freezing processes that helps preserve the flavor and freshness of different components that would react differently to uniform freezing conditions, and helps preserve the shape and distinctness of each component. The use of individually frozen components also facilitates combination of the same types of components in a variety of different ways, and facilitates retention of these pre-disposed components in the arrangement in which they are initially disposed through and preferably beyond the film sealing thereof to the support member. The fact that the components are preferably individually frozen makes it possible to make quick and easy variations in the composition, i.e., the types of components of the meal during mass production of such frozen meals while still retaining the freshness, flavor, and visual appeal of the discrete components. This pre-freezing facilitates display of the edible components as a final meal on the support member, which increases the customer allure when the final frozen meal is viewed through the film and optional outer enclosure. The edible components are not mixed, but remain discrete edible components because the frozen edible components are hindered from moving, mixing, or the like, particularly after the film is applied.

After freezing, the components are preferably assembled on the support member. In one embodiment, some or all of the components can be assembled on the support member before being frozen. These not yet frozen components can be hot, warm, room temperature, or even chilled. For example, certain edible components that might not be pre-frozen before assembly on the support member include potatoes, rice, spinach, sauces, and the like. The food components, whether or not pre-frozen, are typically assembled in an amount and layout sufficient to form a visually pleasing meal, e.g., protein, vegetable, and starch each form approximately a ⅓ arc on a round support member, optionally with a garnish in the center; or two smaller components each take ¼ of a square with the larger component disposed on the remaining ½ square support member. The food components are generally all frozen on the support member before the film is applied thereto. Upon optional thawing simply direct heating of the meal from a frozen or thawed state, the edible components remain in substantially the same place on the support member, thereby preserving the appealing appearance of the meal. The meal is made to appear as if the components had been individually heated and arranged on the support member. Preferably, the edible components remain in place from the time the film is disposed about the support member until the film is removed from the support member by the ultimate consumer.

Application of the film to the components and support member is preferably accomplished by vacuum sealing, although any other suitable method can be used, such as modified atmospheric packaging or controlling air pressure from outside the film. Vacuum sealing substantially eliminates, or entirely eliminates, loss of freshness or a reduction in the visual appearance of the frozen meal. Because the components are preferably previously frozen before the film is applied and sealed, the deformation of the components is minimized or entirely avoided during vacuum sealing.

The freezing can be any suitable freezing process, typically mechanical freezing or cryogenic freezing, or a combination thereof. One exemplary freezing method includes quick freezing, such as flash-freezing, of individual types of components in a manner that best preserves that type of component. The process helps lock in all the flavors, juices, vitamins and minerals and allows the products to keep perfectly for long periods. Preferably, however, each type of edible component of the present invention is frozen by the best freezing means possible to retain the most flavor and the visual appeal to form a meal, and then the components are assembled on the support member to form the complete frozen meal and collectively sealed by the film. The frozen discrete food components retain their shape and distinctness on the support member to ensure the desired visual appeal is achieved.

In a preferred embodiment, the process also includes packaging the meal in an outer enclosure that surrounds the meal and contains an aperture therein to permit the consumer to view a portion of the meal through the outer enclosure. Preferably, there are one to four openings in the aperture of the outer enclosure, and more preferably one or two openings in the aperture. The aperture or a portion thereof may be placed on any side of the outer enclosure or on multiple sides so the frozen meal can be seen from more than one direction, thereby facilitating product placement and display to increase consumer interest.

In another embodiment, the process further includes reducing the air pressure of the enclosure by at least about 90 volume percent of the air initially present, and arranging the food components to be separated on the support member. Preferably the air is reduced by at least about 95 volume percent, and more preferably at least about 99 volume percent.

The present invention also relates to a multi-component, frozen meal package that includes a support member on which is disposed a multi-component frozen meal and an outer enclosure with at least one aperture that displays at least about 60 percent of the complete frozen meal. The frozen meal and support member are sealed with the film described herein that is disposed adjacent the frozen meal that conforms and adheres sufficiently tightly to the meal and support member. The film and the support member form an enclosure having a reduced pressure therein, and the film contacts a portion of the support member not covered by food components. The film is sufficiently translucent or transparent to allow a consumer to view a portion of the frozen meal as a complete, multi-component meal ready for serving. Preferably, the multi-component meal and the outer enclosure used are those described herein.

The optional, but preferable, package also preferably is associated with a set of instructions for preparing the frozen meal. These can be provided on or inside the outer enclosure, on the support member itself, on a separate substrate such as paper or printable plastic material included in the outer enclosure, or the like. The instructions typically include details such as microwave cooking times and settings. Preferably, the set of instructions includes directions for safe cooking, e.g., to poke at least one hole in the film with, for example, a fork before cooking, to allow steam to escape from the frozen meal during heating. In one embodiment, the instructions direct the consumer to remove the film before heating in the microwave or conventional oven. Thus, when a suitable support member is used and the film is first removed, the frozen meal can be thawed and/or heated in a conventional oven. In another embodiment, the instructions direct the consumer to remove the film after heating in the microwave.

The present invention also relates to a storage-stable meal that includes at least two different, discrete, individually pre-frozen edible components arranged on a support member to form the frozen storage-stable meal and a microwaveable film disposed adjacent the pre-frozen components that conforms and adheres sufficiently tightly to the components and the support member to form an enclosure having a reduced pressure therein. The film is at least sufficiently translucent or transparent so that a consumer can readily view the discrete edible components therethrough and can view a portion of the frozen meal as a complete, multi-component meal ready for serving. The entire frozen meal is simultaneously microwaveable and can be stored without freezer burn or visible ice crystal formation for at least one month at freezer temperatures.

Preferably, the frozen meal of the invention may be stored for at least about three months, and more preferably for at least about six months while remaining essentially free or entirely free of freezer burn and visible ice crystal formation. Freezer temperatures are typically no higher than about 32° F., and preferably about 28° F. or below, more preferably about 20° F. or below. Advantageously, the taste and freshness of the meal are not detectably different by the consumer when reconstituted and heated after at least about one month, preferably at least about three months, and more preferably at least about six months, under frozen conditions.

### EXAMPLES

The following examples are not intended to limit the scope of the invention, but merely to illustrate representative possibilities concerning the present invention.

### Example 1

### Parmesan Crusted Chicken Breast

The accompanying FIG. 1 illustrates one embodiment of a frozen meal of the present invention. In this embodiment, parmesan-crusted chicken breast, broccoli spears, and potatoes can be disposed on a support member according to the invention. The components can all be frozen, then a film can be provided to seal in the complete meal with discrete components, and most of the air therein can then be removed. The meal has the surprising and unexpected appearance of a meal-ready-to-eat that is visible and visually appealing to a consumer, as the film only minimally impedes the consumer's view of the meal. Upon reheating or thawing, the meal can be eaten after the film is removed.

The term “about,” as used herein, should generally be understood to refer to both numbers in a range of numerals. Moreover, all numerical ranges herein should be understood to include each whole integer within the range.

Although preferred embodiments of the invention have been described in the foregoing description, it will be understood that the invention is not limited to the specific embodiments disclosed herein but is capable of numerous modifications by one of ordinary skill in the art. It will be understood that the materials used and the chemical details may be slightly different or modified from the descriptions herein without departing from the methods and compositions disclosed and taught by the present invention.

What is claimed is:

1. A visually-appealing, multi-component, packaged microwaveable frozen meal comprising:
at least two different, discrete, frozen edible food components arranged on a support member to form a frozen meal that mimics a prepared meal, with the components being palate complementary to together form, after heating, a complete, multi-component meal ready for serving; and
a microwaveable film disposed upon the frozen components and conforming and adhering sufficiently tightly to the components and the support member so as to form an enclosure having a reduced air pressure therein, with the film contacting the support member in a portion of the areas not covered by the food components, wherein the film is sufficiently translucent or transparent so that a consumer can readily view a portion of the frozen meal as a complete, multi-component meal ready for serving.

2. The meal of claim 1, wherein the food components are pre-cooked and pre-frozen prior to being assembled and arranged on the support member.

3. The meal of claim 1, wherein the food components comprise a protein source, a vegetable source, or a starch source, or a combination of two or all three components.

4. The meal of claim 3, wherein the protein source comprises meat, poultry, seafood, or a combination thereof; the vegetable source comprises carrot, broccoli, spinach, peas, peppers, beans, or a combination thereof; and the starch source comprises rice, pasta, potatoes, or a combination thereof.

5. The meal of claim 3, wherein the food components are at least partially separated on the support member.

6. The meal of claim 1, wherein the microwaveable film comprises a thermoplastic component.

7. The meal of claim 1, wherein application of the film reduces or avoids the formation of air pockets between the film, the food components, and the support member, thereby minimizing or preventing visible ice crystal formation, freezer burn, or both on the food components during storage at freezer temperatures.

8. The meal of claim 7, further comprising an outer enclosure for the meal that surrounds the meal and contains an aperture therein to permit the consumer to view a significant portion of the meal through the outer enclosure.

9. The meal of claim 8, wherein the aperture is sufficiently large so that at least about 30 percent of the meal can be seen through the outer enclosure.

10. The meal of claim 8, wherein the outer enclosure comprises a polygonal box having a base and made of a sufficiently rigid material so that it remains upright when disposed on the base.

11. A process for preparing a visually-appealing, multi-component, packaged, microwaveable, frozen meal which comprises:
freezing a plurality of different, discrete edible food components sufficiently so that each type of discrete component retains its shape and distinctness from other edible food components;
arranging the different edible food components on a support member to provide a complete frozen meal that mimics a prepared meal; and
sealing the complete frozen meal with a film disposed upon the frozen components in a manner that conforms and adheres the film sufficiently tightly to the components and the support member so as to form an enclosure having a reduced air pressure therein, with the film contacting the support member in a portion of the areas not covered by the food components, wherein the film is sufficiently translucent or transparent so that a consumer can readily view a portion of the frozen meal as a complete, multi-component meal ready for serving.

12. The process of claim 11, further comprising packaging the meal in an outer enclosure that surrounds the meal and contains an aperture therein to permit the consumer to view a significant portion of the meal through the outer enclosure.

13. The process of claim 11, which further comprises reducing the air pressure of the enclosure by at least about 90 volume percent of the air initially present during the sealing of the film, and arranging the food components to be separated on the support member.

14. A multi-component, frozen meal package comprising:
a support member upon which is disposed a multi-component frozen meal; and
an outer enclosure with at least one aperture that displays at least about 50 percent of the frozen meal, wherein the frozen meal and support member are sealed with a film disposed upon the meal in a manner that conforms and adheres the film sufficiently tightly to the food components of the meal and the support member so as to form an enclosure having a reduced air pressure therein, with the film contacting the support member in a portion of the areas not covered by the food components, wherein the film is sufficiently translucent or transparent so that a consumer can readily view a portion of the frozen meal as a complete, multi-component meal ready for serving.

15. The package of claim 14, wherein the multi-component meal comprises at least two different, discrete, frozen edible food components arranged on a support member to form a frozen meal that mimics a prepared meal, with the components being palate complementary to together form, after heating, a complete, multi-component meal ready for serving.

16. The package of claim 14, wherein the outer enclosure comprises a polygonal box having a base and made of a sufficiently rigid material so that it remains upright when disposed on the base.

17. The package of claim 14, further comprising a set of instructions for preparing the frozen meal.

18. A storage-stable meal comprising:
at least two different, discrete, individually pre-frozen edible components arranged on a support member to form the storage-stable meal; and
a microwaveable film disposed adjacent the pre-frozen components that conforms and adheres sufficiently tightly to the components and the support member so as to form an enclosure having a reduced air pressure therein, with the film contacting the support member in a portion of the areas not covered by the food components, wherein the film is sufficiently translucent or transparent so that a consumer can readily view a portion of the frozen meal as a complete, multi-component meal ready for serving, wherein the entire storage-stable meal is simultaneously microwaveable and can be stored essentially free of freezer burn or visible ice crystal formation for at least about one month at freezer temperatures.

19. The meal of claim 18, wherein the taste and freshness of the meal are not detectably different to the consumer after at least about one month under frozen conditions.

20. The meal of claim 18, wherein the storage-stable meal is at least essentially free of freezer burn and visible ice crystal formation after at least about three months' storage at freezer temperatures.

21. The meal of claim 18, wherein the storage-stable meal is at least essentially free of freezer burn and visible ice crystal formation after at least about six months' storage at freezer temperatures.
